(19) United States
(12) Patent Application Publication
(10) Pub. No.: US 2012/0138105 A1
(43) Pub. Date: Jun. 7, 2012

(54) ROBOTISED DEVICE OF CLEANING OF EXTERNAL STEEL STRUCTURES

(75) Inventor: Jordi Masia Perales, L'Alcudia (Valencia) (ES)

(73) Assignee: ELIOT SYSTEMS, S.L., L'Alcudia (Valencia) (ES)

(21) Appl. No.: 13/124,098

(22) PCT Filed: Dec. 2, 2010
(86) PCT No.: PCT/ES10/70795

§ 371 Date: Jun. 17, 2011

(51) Int. Cl. B08B 3/02; B08B 7/00; B08B 3/08

(52) U.S. Cl. 134/99.2

(57) ABSTRACT

Robotized cleaning device used on ferromagnetic structures that includes two symmetrical cleaning arms (100, 200) and a caterpillar type tractor (300) device that moves using magnetic soles over the bands of said caterpillar robot; and where said arms (100, 200) are jointly attached to the tractor device (300) by means of a structural profile and are essentially comprised of a cleaning roller (1), each of them operated by a reduction motor (4) coupled to said roller (1) and a plurality of nozzles.

This invention refers to a robotized cleaning device for use on surfaces and external or internal parts of large ferromagnetic structures such as wind turbine towers.

### STATE OF THE ART

In the current state of the art, the treatment and/or work on surfaces or parts of ferromagnetic structures is common in the maintenance of skyscrapers, ships and other large structures that require periodic cleaning and/or painting. Also, the maintenance of a building that has a large dome is not easy for the operators to accomplish and is only practical when using scaffolding.

Nowadays, this work is carried out using travelling bridges, which are raised, lowered and moved along the entire surface of the structure; this method imposes a risk to the workers on board the bridge.

Also common is the periodic maintenance required to be carried out on wind generators, which must be cleaned every certain amount of time to prevent jamming due to grease falling from the wind generator itself, which may even cause the barge to seize. These tasks must be carried out using qualified personnel as well as the proper materials and equipment for working at heights. This way, the workers located at heights along the surfaces are always exposed to the risk of suffering accidents and falls. Also, this type of work requires the wind generator to be stopped temporarily with the consequent loss in productivity while the cleaning is being carried out.

Magnetic caterpillar robots, as for example in patent EP 1 650 116, are known where the means for actuation consist of two opposite and independent motors, which remotely and independently control the two opposite caterpillars. This way, the robot can be moved in any direction by moving either of the robot's caterpillars.

The problem with these types of robots is that they are difficult to move equally in any direction.

To solve this problem, European patent EP 1 924 487 was introduced, which describes a robot for treating and/or work on surfaces or external parts of large ferromagnetic structures, where said robot is of the caterpillar type, which moves using magnetic soles over the bands of said caterpillar robot, and includes two independent actuating units, each of them primarily using a ball joint that allows rotation with respect to the central body transversely and subsequently by means of a longitudinal hinge, which allows a high degree of freedom with respect to the other band, since it allows turning each of them transversely as well as longitudinally.

Arms have been installed behind each unit and each of these arms has a magnetic band with freedom to transit and are supported by free rotating wheels.

However, this robot lacks a cleaning system that allows not only movement, but also cleaning of the surface over which the robot is travelling over.

### DESCRIPTION OF THE INVENTION

The robotized cleaning device used on external or internal ferromagnetic structures that is described in this invention includes two symmetrical cleaning arms and a caterpillar type tractor device that moves using magnetic soles over the bands of said caterpillar robot, including two independent actuating units that use longitudinal hinges on both sides, one with the other in an intermediate position with respect to the lateral hinges; said lateral hinges including at least an intermediate longitudinal hinge with an intermediate longitudinal axis that is substantially capable of allowing one unit to oscillate laterally and transversely with respect to the other and where the lateral hinges also include a transversal hinge, where said transversal hinge includes a transversal rotating coupling that is substantially capable of allowing one unit to turn with respect to the central body and where arms are installed behind each unit, where each arm is supported by means of respective free rotating wheels; where each cleaning arm is characterized because said arms are jointly attached to the tractor device using a structural profile section and are essentially comprised of a cleaning roller, each of them operated by a reduction motor coupled to said roller and a plurality of nozzles configured for spraying chemical products, pure as well as diluted (depending on the need) over the surface to be cleaned. The chemical product dosing is carried out using a dosing pump. This procedure is carried out by letting the chemicals act for the required time and subsequently using the roller system in the proper direction, and rinsing with water from a container located on the ground. The system is comprised of pipes mounted on nozzles, which can be used for spraying chemicals as well as water. The usage of the pipes depend on the need; they can be used going up as well as going down, spraying chemical products or rinsing with water.

The roller includes a rubber piece configured so that when it is cleaning, the dirt, water residue and chemical products employed in the cleaning are pushed outward. This rubber piece is located between the caterpillars and the roller cover.

This solves the technical problem derived from the joining of a robotized tractor device with a means for cleaning, which allows to independently clean ferromagnetic surfaces, which previously required using qualified operators to accomplish.

Throughout the description and claims, the word “encompasses” and its synonyms do not intend to exclude other technical characteristics, additions, components or steps. For experts in the field, other objectives, advantages and characteristics of this invention will in part be derived from the description and in part from placing the invention into practice. The following examples and drawings provide an illustration and are not intended to limit this invention. Additionally, this invention covers all the possible combinations of particular and preferred embodiments indicated herein.

### BRIEF DESCRIPTION OF THE DRAWINGS

FIG. 1. Shows a view of one of the symmetrical arms that comprise the cleaning means and are an integral part of the robotized ferromagnetic structures cleaning device described in this invention.

FIG. 2. Shows a bottom view of the arm shown in FIG. 1

FIG. 3. Shows a view of the robotized ferromagnetic structures cleaning device assembly described in this invention.

FIG. 4. Shows a view of the assembly of FIG. 3 that only shows the actuating unit and one arm.

### DETAILED DESCRIPTION OF A METHOD OF EMBODIMENT

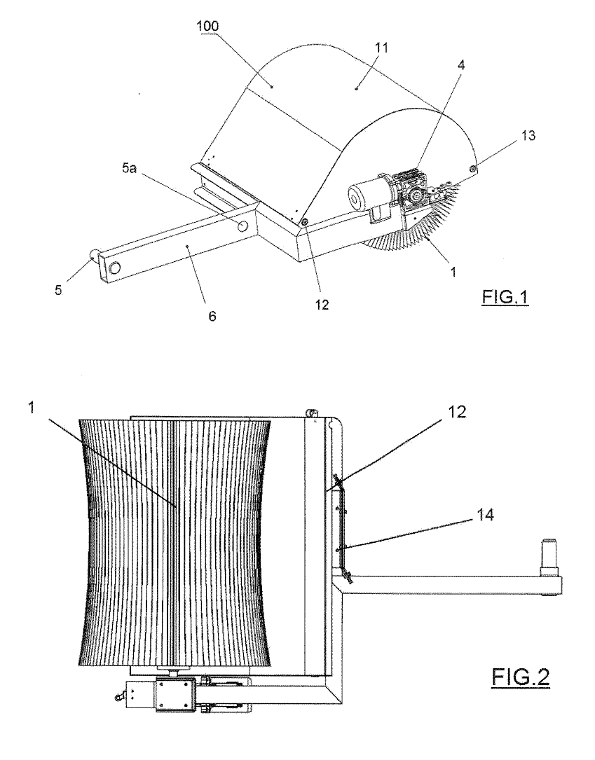

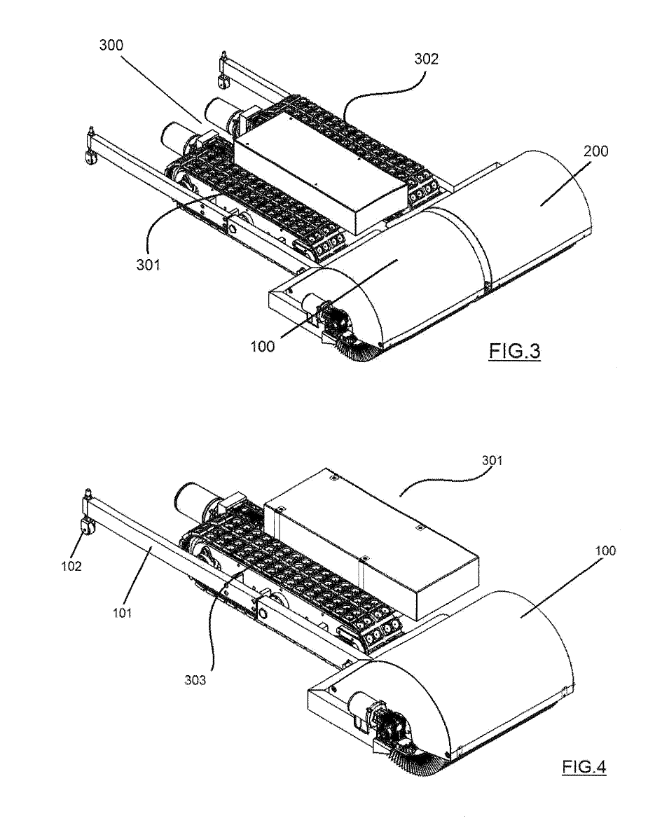

As shown in the attached figures, the cleaning means incorporated in the robotized device described in this invention, essentially include two symmetrical arms (100, 200) represented in FIG. 1, which are jointly attached to a tractor device or robot (300), which travels by means of a system of belts and magnets and is configured for cleaning metal surfaces, removing grease as well as oil spots and other dirt that is present in large ferromagnetic structures such as for example, wind generator towers or other metal surfaces.

Said magnets include a type of PVC “shoe” that lessens the angle of attack of the magnet with the metal surface, aiding its operation. The attached figures show how the cleaning arms (100, 200) are essentially comprised of a cleaning roller (1) and each of them is operated by a reduction motor (4) coupled to said roller (1) and a plurality of nozzles (14) coupled to the pipes (12) and (13) and configured for providing:
Water for rinsing the surfaces.
Chemical products in pure form as well as diluted with water.

The chemical products are dosed by a dosing pump and travel from the chemical products tank to the chemical products pipes (13).

In a normal operation of the cleaning arms (100, 200), these are coupled to the tractor machine (300) as seen in FIG. 2, and are divided into two independent actuating units (301, 302); where each one of these actuating units (301, 302) are joined to each other by means of a ball joint that allows transversal rotation with respect to the central body and are also joined by a longitudinal hinge that allows each actuating unit to turn transversely as well as longitudinally; and where behind each actuating unit (301, 302), arms (101) are installed, at least one per actuating unit, where each arm (101) is supported by respective free rotating wheels (102).

Subsequently, the water pump is turned on, which pumps water out from an external tank and enables the nozzles (14) to spray water and chemical product, in pure or diluted form over the metal surface.

After this, the rollers (1) are actuated by their respective reduction motor (4), causing said roller (1) to start turning. At this moment, the tractor machine (300) is literally adhered to the ferromagnetic surface thanks to the magnets it has installed on the tractor chain 303, which enables the assembly to move up said structure.

At the start of the movement, the dosing pump that is connected to the cleaning fluid tank starts, enabling the chemical cleaning product contained in said tank to flow through hoses connected to distribution pipes that are common in water installations, and where said pipes are housed inside the roller cover (11).

The structural joining profile (6) is configured for joining the roller (1)-motor (4), located at the end of the structural profile (6). Said roller (1) holding profile (6) is attached to the tractor system by means of two attaching points, one common (5) and another threaded (5a), which can be adjusted depending on the desired strength with which it is fastened to the metal surface.

Once the roller (1) is spinning and is therefore cleaning the surface to be treated, water is sprayed over said rollers (1) which will rinse what has already been cleaned and remove the water along with the excess chemical product and the dirt, which are removed from the treated surface.

This cleaning of the chemical product, water and residue is materialized by means of a rubber piece located midway between the roller (1) and the tractor's (300) caterpillars.

An arm (101) is installed on the back side of the roller position with a support wheel (102) that acts as a crowbar in such a manner that, when in the operating position, it compensates for the weight of said roller and facilitates the pushing action of the tractor (300) device.

### Use of the Device for Cleaning Wind Generator Towers

A non-limiting application of the robotized device described in this invention is the cleaning of wind generator towers, which allows cleaning the towers without having to stop them from operating. This cleaning is carried out going up as well as going down. In this specific application, the operating sequence of the device is described below:
1) All electrical as well as water and chemical product pipe connections are connected. The external pump adjacent to the external water tank is started.
2) A cycle is carried out, which will be repeated as many times as necessary for cleaning the wind generator.
3) Step 1. Spraying
   Actuation of the chemical product spray nozzles (14) that are located on the piping (13), depositing the product on the tower as the tractor (300) travels upward at a distance that may vary depending on the drying of said chemical product.
4) Step 2. Rinsing-Spraying.
   Rinsing: Upon reaching the desired position for the tractor (300), the reduction motors (4) for the rollers (1) are started, which are rinsed with sprayed water from the water pipes (12); the constant rubbing of the roller (1) as it is climbing will clean the surface, pushing the dirt as well as the chemical product outward.
   Spraying: At the same time the metal surface is being sprayed with the chemical product through the spray nozzles located on the chemical product pipe (13) in order to begin treating the surface prior to starting over with the rinsing cycle.
   Removal of residues: As the roller is spinning, the dirty water and chemical products residue are pushed towards the sides by a rubber piece to prevent the residue from falling on the magnets and cause a loss of adherence.
5) Upon completion of both steps, we find ourselves in a higher position than in step 1 and it will be at that moment when we restart the cycle.
6) When we reach the top part of the wind generator, we will descend with a slight inclination in order to reach a position where we can restart the cycle.
7) These steps will be repeated until the wind generator has been cleaned completely.
8) Disconnection of the external pump.
9) Disconnecting of all electrical systems as well as of the water pipes and chemical product pipes.

1. Robotized cleaning device used on ferromagnetic structures and includes two symmetrical cleaning arms (100, 200) and a caterpillar type tractor (300) device that moves using magnetic soles over the bands of said caterpillar robot, including two independent actuating units (301, 302); where each of these actuating units (301, 302) are joined together by means of a ball joint that allows for transverse rotation with respect to the central body and also joined by a longitudinal hinge that enables each actuating unit to turn transversely as well as longitudinally, and where behind each actuating unit (301, 302), arms (101) are installed, at least one per actuating unit, and where each arm (101) is supported by means of respective free rotating wheels (102) and is characterized in that
aligned with each arm (101) is a profile (6) that supports the cleaning roller (1), each of them operated by a reduction motor (4) that is coupled to said roller (1) and a plurality of pipes configured for spraying water (12) and for spraying chemical product (13) through a plurality of spray nozzles (14), in such a manner that the spraying of chemical product in pure as well as diluted form is sprayed over the ferromagnetic surface.

2. Device in accordance with claim 1 where the dosing of the chemical product is carried out using a dosing pump, letting the pump run for the proper amount of time and then running the rollers in the proper direction, followed by rinsing with water from a tank that is located on the ground.

3. Device in accordance with the aforementioned claims where the spray nozzles (14) are shared by the water and the chemical product, and where the pipes are used on an as needed basis, and can be used going up as well as going down, spraying chemical product or water for rinsing.

4. Device in accordance with the aforementioned claims where the water is taken from an external tank, pumped out using an external electrical pump, which feeds an external pipe that is connected to the plurality of pipes (12, 13).

5. Device in accordance with the aforementioned claims that is characterized in that the first chemical product distribution pipe (13) is located in front of the roller (1), while the second water distribution pipe (12) is located behind the roller (1), where the entry of water or product is interchangeable.

6. Device in accordance with the aforementioned claims that is characterized in that the first and second plurality of pipes (12, 13) are housed inside the casing (11) that is external to the rollers (1).

7. device in accordance with the aforementioned claims that is characterized in that the structural joint profile (6) is configured for joining the roller assembly (1)-motor (4) that is located on a first edge of the profile (6), with the rest of items that comprise the arms (100, 200) especially with the cleaning fluid tank and the dosing pump located at the exit of said tank; and where joined to the profiles are electric valves housed inside a box that has been installed for this purpose.

8. Device in accordance with the aforementioned claims that is characterized in that the structural profile (6) is joined to the tractor device (300) by means of an adjustable threaded joint and a common built-in joint that allows for better coupling to the metal surface.

9. Device in accordance with the aforementioned claims that is characterized in that said residue is routed towards the exterior by means of a rubber piece that sprays all the residues outward, thanks to the action of the rollers that removes the dirt from the metal surface.

10. Device in accordance with the aforementioned claims that is characterized in that the cleaning arms (100, 200) are aligned with other profiles (101) that include a support wheel (102), located on the back side of the roller (1), in such a manner that when in the operating position, it compensates for the weight of said roller and facilitates the pushing action of the tractor device (300).

11. Device in accordance with the aforementioned claims that is characterized in that the caterpillar itself (303) couples to a pinion that prevents the caterpillar from decoupling and where also the caterpillar (303) includes a plurality of magnets that incorporate a plurality of PVC components that lessen the angle of attach of the magnet with the metal surface.
